(19) United States
(12) Patent Application Publication
(10) Pub. No.: US 2024/0383543 A1
(43) Pub. Date: Nov. 21, 2024

(54) AERODYNAMIC CARGO TRANSPORT

(71) Applicant: STI Holdings, Inc., Stoughton, WI (US)

(72) Inventors: Denys Bykovskyi, Madison, WI (US); Gary Lynn Fenton, Edgerton, WI (US)

(21) Appl. No.: 18/667,843

(22) Filed: May 17, 2024

Related U.S. Application Data
(60) Provisional application No. 63/503,303, filed on May 19, 2023.

(51) Int. Cl. B62D 35/00; B62D 33/04

(52) U.S. Cl. CPC B62D 35/001; B62D 33/04

(57) ABSTRACT

A cargo transport includes a cargo area defined by a front wall, a plurality of side walls, and a roof. A front upper rail is disposed between the front wall and the roof and configured to couple the front wall to the roof. A plurality of side upper rails is disposed between the plurality of side walls and the roof and configured to couple the plurality of side walls to the roof. A front aerodynamic insert is coupled to the front upper rail, and a plurality of side aerodynamic inserts is coupled to the plurality of side upper rails. Each of the aerodynamic inserts is configured to direct airflow from the front wall or the plurality of side walls onto the roof.

### CROSS-REFERENCE TO RELATED APPLICATIONS

This application claims priority to U.S. Provisional Patent Application No. 63/503,303, filed on May 19, 2023, the entire contents of which are incorporated herein by reference.

### BACKGROUND

The invention relates to over-the-road trailers or cargo transports and in particular, to the over-the road trailers or cargo transports with structures to increase aerodynamic efficiency during operation.

### SUMMARY

In one aspect, a cargo transport includes a cargo area defined by a front wall, a plurality of side walls, and a roof. A front upper rail is disposed between the front wall and the roof and configured to couple the front wall to the roof. A plurality of side upper rails is disposed between the plurality of side walls and the roof and configured to couple the plurality of side walls to the roof. A front aerodynamic insert is coupled to the front upper rail, and a plurality of side aerodynamic inserts is coupled to the plurality of side upper rails. Each of the aerodynamic inserts is configured to direct airflow from the front wall or the plurality of side walls onto the roof.

In another aspect, a cargo transport includes a cargo area defined by a front wall, a plurality of side walls, and a roof. A front upper rail is disposed between the front wall and the roof and configured to couple the front wall to the roof. A plurality of side upper rails is disposed between the plurality of side walls and the roof and configured to couple the plurality of side walls to the roof. A front aerodynamic insert is coupled to the front upper rail, and a plurality of side aerodynamic inserts is coupled to the plurality of side upper rails. The front upper rail includes a cavity to which the front aerodynamic insert is coupled. The front aerodynamic insert is secured within the cavity such that a connection between the front aerodynamic insert and the front upper rail is not within a path of airflow over the front aerodynamic insert when in use.

In yet another aspect, a cargo transport includes a cargo area defined by a front wall, a plurality of side walls, and a roof. A front upper rail is disposed between the front wall and the roof and configured to couple the front wall to the roof. A plurality of side upper rails is disposed between the plurality of side walls and the roof and configured to couple the plurality of side walls to the roof. A front aerodynamic insert is coupled to the front upper rail. The front aerodynamic insert includes a body configured to fit within a cavity of the front upper rail to couple the front aerodynamic insert to the front upper rail. The front aerodynamic insert further includes an outer surface configured to direct airflow from the front wall onto the roof. The outer surface includes a convex curved portion adjacent to the front wall and a concave curved portion extending from the convex curved portion.

### BRIEF DESCRIPTION OF THE DRAWINGS

FIG. 1 is front perspective view of a trailer according to one embodiment of the present disclosure.

FIG. 2 is a close-up perspective view of an upper corner of the trailer of FIG. 1.

FIG. 3 is a cross-sectional view of a portion of an upper rail.

FIG. 4 is a cross-sectional view of an insert for use with the upper rail of FIG. 3.

FIG. 5 is a perspective view of an end connector for use with the insert of FIG. 4.

FIG. 6 is a perspective view of a corner casting.

### DETAILED DESCRIPTION

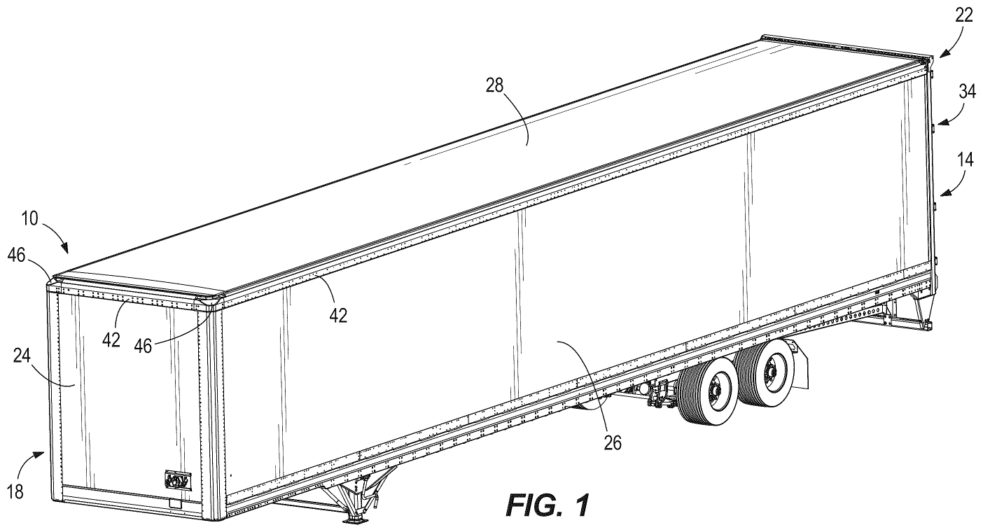

FIG. 1 illustrates a trailer 10, such as an enclosed over-the-road commercial transport semi-trailer or “dry van,” although the trailer may take a variety of other configurations. The trailer 10 includes a cargo area 14 defined between a front or leading end 18 and a rear or trailing end 22. The cargo area 14 includes a front wall 24, a plurality of side walls 26 and a roof 28 that at least partially define an interior space which contains cargo when the trailer 10 is in use. An opening 34 is positioned at the rear end 22 to allow for loading and unloading of cargo. As will be understood by one of ordinary skill in the art, increasing fuel efficiency decreases operating costs of the trailer 10. Increasing fuel efficiency can be accomplished in many ways. For example, improving the aerodynamic efficiency of the trailer 10 (e.g., reducing aerodynamic drag) is one method for increasing fuel efficiency. One way to improve aerodynamic efficiency is to improve airflow onto the roof 28 of the trailer 10 from the front wall 24 and/or the plurality of side walls 26.

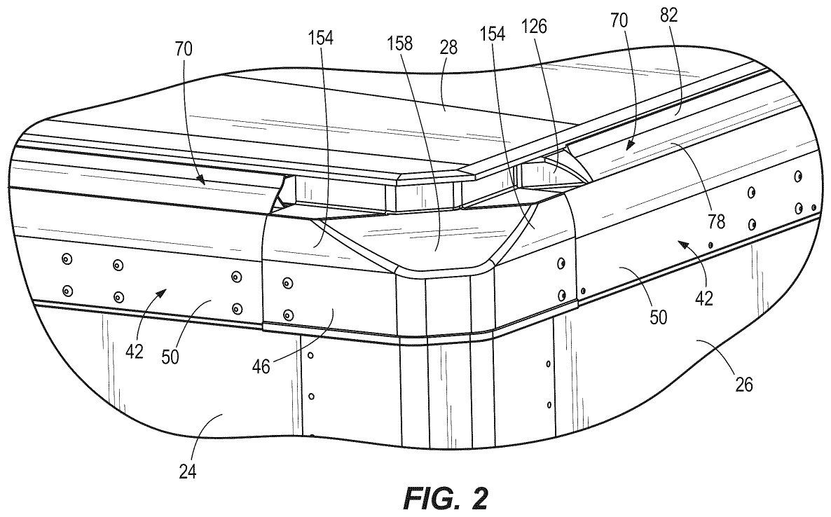

With reference to FIGS. 1 and 2, the trailer 10 includes a plurality of upper rails 42 (e.g., a front upper rail 42 and a plurality of side upper rails 42) to couple the front wall 24 or the side walls 26, respectively, to the roof 28. The trailer 10 also includes a plurality of corner castings 46 to couple the front wall 24, the side wall 26, the roof 28, and the respective upper rails 42. Each of the upper rails 42 and the corner castings 46 include features to improve aerodynamic efficiency of the trailer 10 by improving airflow from the front or side walls 24, 26 about the upper rails 42 and the corner castings 46 to the roof 28. While the trailer 10 includes multiple upper rails 42 and corner castings 46, each upper rail 42 includes similar features and each corner casting 46 includes similar features. Accordingly, only one upper rail 42 and one corner casting 46 is described in detail herein.

With reference to FIGS. 1-3, the upper rail 42 includes a vertical portion 50 to be coupled to the side wall 26 (or the front wall 24). The vertical portion 50 is coupled to an outer surface of the side wall 26 (or the front wall 24). In some embodiments, the vertical portion 50 may be coupled to an inner surface of the side wall 26 (or the front wall 24). The vertical portion 50 forms a straight and flat surface to be coupled to the side wall 26 (or the front wall 24). The vertical portion 50 is generally planar and is fastened to an outer surface of the side wall 26 (or the front wall 24). In the illustrated embodiment, the vertical portion 50 is riveted to the side wall 26 (or the front wall 24). The vertical portion 50, however, may be adhered to the side wall 26 (or the front wall 24) via an adhesive or other bonding method or a combination of an adhesive and rivets. A flange 54 extends inwardly (e.g., towards an interior of the cargo area 14) from a top end of the vertical portion 50 and engages an upper edge of the side wall 26 (or the front wall 24). In an embodiment in which the vertical portion 50 is coupled to an inner surface of the side wall 26 (or the front wall 24), the flange 54 extends outwardly (e.g., towards an exterior of the trailer 10). The flange 54 aligns the upper rail 42 and the side wall 26 (or the front wall 24) during assembly and assists in securing the upper rail 42 to the side wall 26 (or the front wall 24). A curved portion 58 of the upper rail 42 extends upwardly from the vertical portion 50. The curved portion 58 forms a convex surface that directs airflow around the upper rail 42 (e.g., from the side wall 26, or the front wall 24, towards the roof 28). The upper rail 42 further includes a roof support 62 spaced vertically and horizontally from the curved portion 58. The roof support 62 is oriented approximately transverse to the vertical portion 50 to support the roof 28 relative to the side wall 26 (or the front wall 24). The roof support 62 is positioned at an angle A relative to the vertical (i.e., the vertical portion 50). The angle A may be greater than 45 degrees, and more particularly may be greater than 75 degrees. The angle A may be less than 100 degrees and, in the illustrated embodiment is less than 93 degrees. Similar to the vertical portion 50, the roof support 62 is fastened to the roof 28 via rivets, adhesives, other bonding methods and/or a combination of rivets and other bonding methods. A cavity 66 is defined within the upper rail 42 between the roof support 62 and the curved portion 58. As will be described in greater detail herein, the cavity 66 supports an aerodynamic insert 70 (e.g., a front aerodynamic insert 70 coupled to the front upper rail 42 and a plurality of side aerodynamic inserts 70 coupled to the side upper rails 42) that assists the curved portion 58 in directing airflow around the upper rail 42. The upper rail 42 may be formed of aluminum or, in some constructions, the upper rail 42 may be formed of other extruded, pultruded, or cast materials including, for example, steel or composites.

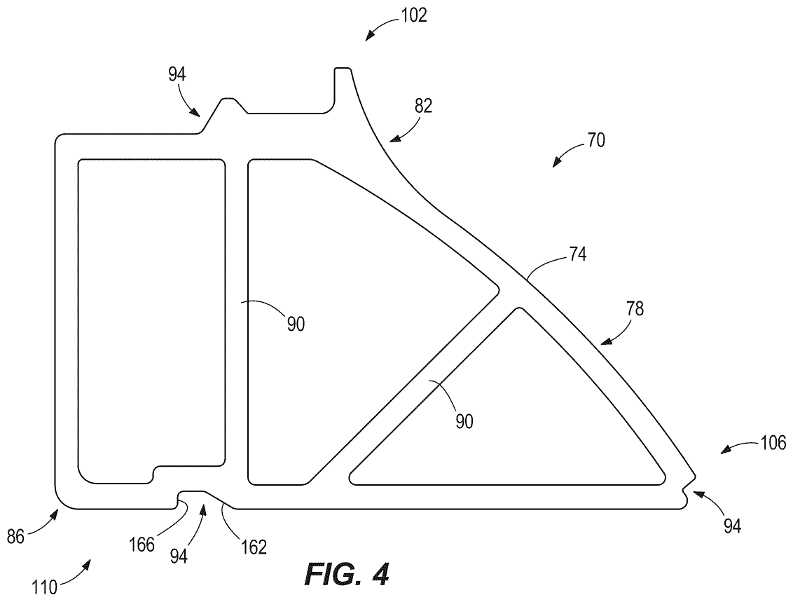

With continued reference to FIGS. 1, 2, and 4, the insert 70, when disposed within the cavity 66, extends along the upper rail 42. In the illustrated embodiment, the insert 70 extends along substantially the entire length of the upper rail 42. However, in other constructions the insert 70 may extend along only a portion of the length of the upper rail 42, and a plurality of inserts 70 may be positioned within the upper rail 42. The insert 70 fills the cavity 66 between the roof support 62 and the curved portion 58 to direct airflow around the upper rail 42, thereby increasing aerodynamic efficiency of the trailer 10. Referring to FIG. 4, an outer surface 74 of the insert 70 includes a convex curved portion 78 and a concave curved portion 82. The convex curved portion 78 and the concave curved portion 82 can be tangent to each other to define a seamless transition. The convex curved portion 78 has a similar (e.g., matching) radius of curvature to the curved portion 58 of the upper rail 42. The concave curved portion 82 is positioned near the roof support 62 and shaped to direct airflow on top of the roof 28 from the convex curved portion 78. A body 86 of the insert 70 is shaped to fit within the cavity 66 and is generally rectangular in cross-section. The body 86 is hollow and includes an inner structure 90 (e.g., one or more reinforcement walls) supporting the outer surface 74. The insert 70 is flexible and may be formed of plastic, rubber, or another similar material or combination thereof.

With reference to FIGS. 1-4, the insert 70 is secured within the cavity 66 of the upper rail 42 via a snap-fit or other self-stable connection. The connection is made within the cavity 66 to avoid interfering with airflow over the insert 70. The insert 70, therefore, includes a plurality of recesses 94, and the upper rail 42 includes a plurality of protrusions 98 dimensioned to create interference with the recesses 94 when the insert 70 is snap-fit into the cavity 66. In other words, the recesses 94 and the protrusions 98 can define the connection referred to above. In some constructions, this may be the sole connection coupling the insert 70 to the upper rail 42. In some constructions, dimensional interference is maintained while the insert 70 is statically positioned within the operational position in the cavity 66, so as to define an interference fit. In the illustrated embodiment, the insert 70 includes three recesses 94 positioned at an upper portion 102, an outer portion 106, and an inner portion 110 of the insert 70. Similarly, the upper rail 42 includes three protrusions 98 positioned at an upper portion 114 (e.g., near the roof support 62), an outer portion 118 (e.g., near a transition from the curved portion 58 to the cavity 66), and an inner portion 122 (e.g., near the interior of the cavity 66). The recess 94 located at the upper portion 102 of the insert 70 forms an angled or ramped surface that is engageable by the corresponding protrusion 98. The recess 94 located at the outer portion 106 is generally triangular to receive the corresponding protrusion 98 therein. Finally, the recess 94 located at the inner portion 110 of the insert includes a ramped surface 162 and a flat engagement surface 166. The corresponding protrusion 98 also includes a ramped surface 170 and a flat engagement surface 174. When the insert 70 is coupled to the upper rail 42, the protrusions 98 are disposed within the similarly shaped recesses 94.

Referring to FIGS. 2-4, the insert 70 is sized such that an uppermost edge of the concave portion 82 is positioned below the roof 28 and the upper portion 114 of the upper rail 42. However, in other construction, the concave portion 82 may have an uppermost edge that extends to or above a top edge of the upper rail 42 and/or the roof 28.

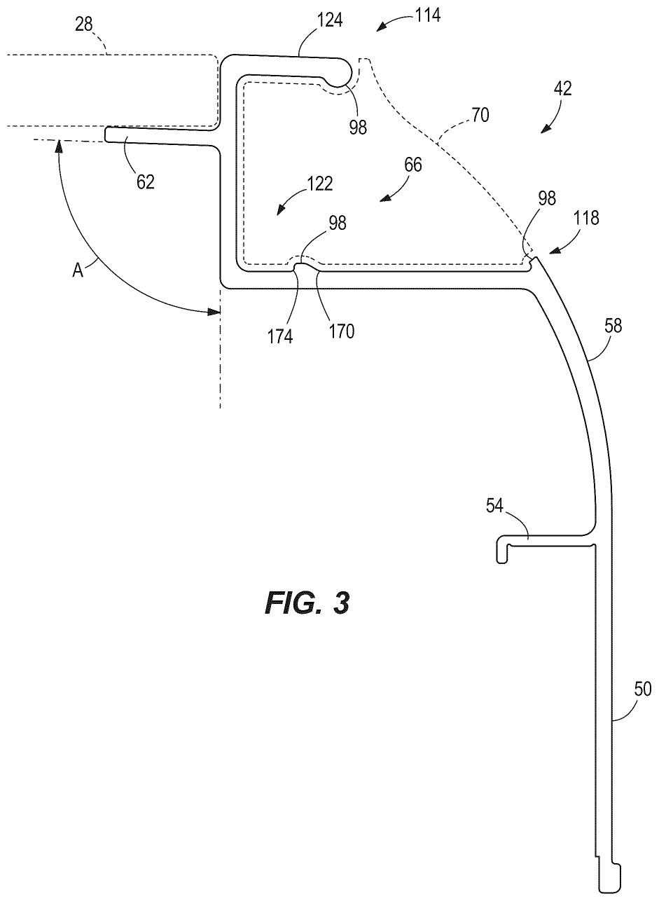

With reference to FIGS. 3 and 4, the roof support 62 is cambered or angled relative to horizontal such that the roof 28 is non-perpendicular to the vertical portion 50 and/or the side wall 26 (or front wall 24). As mentioned above, the roof support 62 is positioned at approximately 93 degrees relative to the vertical portion. An upper surface 124 of the upper rail 42 is disposed above the roof support 62 by an amount equal to a thickness of the roof 28. Thus, the upper surface 124 is positioned to be approximately planar with the roof 28 and is angled similar to the roof support 62. Thus, as air flows over the insert 70, the air passes over the concave curved portion 82 and onto the upper surface 124 of the upper rail 42 to transition to the roof 28 (FIG. 3).

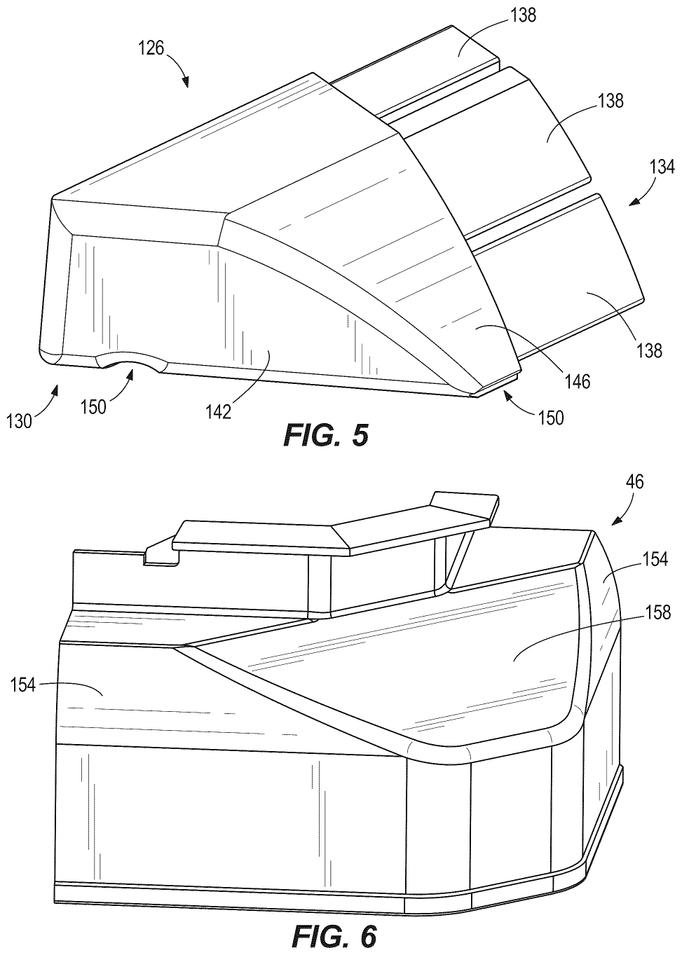

With reference to FIGS. 1, 2, and 5, an end connector 126 may be couplable to the insert 70 to assist in directing airflow about the insert 70 and the upper rail 42. Referring to FIG. 2, the end connector 126 is coupled to the insert 70 that is disposed between the sidewall 26 and the roof 28. When the end connector 126 is coupled to the insert 70, the end connector 126 is also located within the cavity 66. The end connector 126 is operable to close off the hollow(s) of body 86 of the insert 70 to inhibit air from flowing through the insert 70. With reference to FIG. 5, the end connector 126 includes an exterior end 130 to direct airflow around the insert 70 and an interior end 134 to couple the end connector 126 to the insert 70. The interior end 134 includes a plurality of protrusions 138 corresponding in shape to the inner structure 90 of the insert 70. The exterior end 130 is curved to direct airflow around the insert 70. A first curved surface 142 is concave and is a leading surface (e.g., forward surface) during operating. The first curved surface 142 directs airflow outward or away from the trailer 10 rather than into the hollow(s) of body 86 of the insert 70. A second curved surface 146 is convex. The second curved surface 146 abuts and aligns with the convex curved portion 78 of the insert 70. The end connector 126 is securable to both the insert 70 and to the upper rail 42. The plurality of protrusions 138 of the interior end 134 are sized to create a self-stable (e.g., interference) fit within the hollow(s) of body 86 of the insert 70. The end connector 126 also includes recesses 150, positioned similarly to the recesses 94 of the insert 70, to be engaged by some or all of the protrusions 98 of the upper rail 42 in a snap-fit connection. The end connector 126 is formed from a plastic material that is UV and impact resistant.

With reference to FIGS. 1, 2, and 6, the corner casting 46 couples the front wall 24, side wall 26, and roof 28, and the corner casting 46 of the present disclosure includes features to increase aerodynamic efficiency. The corner casting 46 includes curved portions 154 to direct air from the front and/or sidewalls 24, 26 onto the roof 28. The corner casting 46 further includes a chamfer 158 to improve airflow from the front wall 24 toward the side wall 26. In the illustrated embodiment, the corner casting 46 is formed of aluminum. However, in other constructions the corner casting 46 may be formed from other materials including steel or composites.

In use, the upper rail 42 and the corner casting 46 increase fuel efficiency of the trailer 10 by increasing the overall aerodynamic efficiency of the trailer 10. The insert 70 and end connector 126 supported by the upper rail 42 improve airflow over and along the upper rail 42. Similarly, the corner casting 46 improves airflow at a junction between the front wall 24, the side wall 26, and the roof 28.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, one having ordinary skill in the art will appreciate that specific features of the numerous embodiments disclosed may be mixed and matched in other ways where not specifically inhibited, even though specific illustration of such embodiments may not be exhaustively covered herein.

What is claimed is:

1. A cargo transport comprising:
a cargo area defined by a front wall, a plurality of side walls, and a roof;
a front upper rail disposed between the front wall and the roof and configured to couple the front wall to the roof;
a plurality of side upper rails disposed between the plurality of side walls and the roof and configured to couple the plurality of side walls to the roof;
a front aerodynamic insert coupled to the front upper rail; and
a plurality of side aerodynamic inserts coupled to the plurality of side upper rails,
wherein each of the aerodynamic inserts is configured to direct airflow from the front wall or the plurality of side walls onto the roof.

2. The cargo transport of claim 1, wherein the front upper rail includes a vertical portion to be coupled to the front wall and a roof support spaced from the vertical portion to be coupled to the roof, wherein the front aerodynamic insert is coupled to the front upper rail between the roof support and the vertical portion.

3. The cargo transport of claim 2, wherein the front upper rail includes a curved portion extending from the vertical portion, the curved portion disposed between the vertical portion and the aerodynamic insert and configured to direct airflow onto the aerodynamic insert.

4. The cargo transport of claim 3, wherein the aerodynamic insert includes a convex curved portion having a similar radius of curvature as the curved portion of the front upper rail.

5. The cargo transport of claim 4, wherein the convex curved portion transitions to a concave curved portion opposite the curved portion of the front upper rail, the concave curved portion configured to direct airflow upwards on top of the roof.

6. The cargo transport of claim 1, wherein the front aerodynamic insert and the plurality of side aerodynamic inserts have the same shape.

7. A cargo transport comprising:
a cargo area defined by a front wall, a plurality of side walls, and a roof;
a front upper rail disposed between the front wall and the roof and configured to couple the front wall to the roof;
a plurality of side upper rails disposed between the plurality of side walls and the roof and configured to couple the plurality of side walls to the roof;
a front aerodynamic insert coupled to the front upper rail; and
a plurality of side aerodynamic inserts coupled to the plurality of side upper rails,
wherein the front upper rail includes a cavity to which the front aerodynamic insert is coupled, and
wherein the front aerodynamic insert is secured to the front upper rail within the cavity such that a connection between the front aerodynamic insert and the front upper rail is not within a path of airflow over the front aerodynamic insert when in use.

8. The cargo transport of claim 7, wherein the front upper rail includes a vertical portion to be coupled to the front wall and a roof support spaced from the vertical portion to be coupled to the roof, and wherein the cavity is disposed between the vertical portion and the roof support such that the front aerodynamic insert is positioned between the front wall and the roof.

9. The cargo transport of claim 8, wherein the front aerodynamic insert includes an outer surface configured to direct airflow onto the roof, the outer surface including a convex curved portion adjacent to the vertical portion of the front upper rail and a concave portion extending from the convex curved portion opposite the vertical portion of the front upper rail.

10. The cargo transport of claim 9, wherein the convex curved portion transitions smoothly to the concave curved portion.

11. The cargo transport of claim 7, wherein the front upper rail includes a plurality of protrusions, and wherein the front aerodynamic insert includes a plurality of recesses, the plurality of recesses configured to receive the plurality of protrusions therein to couple the front aerodynamic insert to front upper rail.

12. The cargo transport of claim 11, wherein the plurality of protrusions are sized to be snap-fit to the plurality of recesses.

13. The cargo transport of claim 7, wherein each of the plurality of side upper rails includes a cavity to which the respective side aerodynamic insert is coupled, and wherein the plurality of side aerodynamic inserts is secured to the plurality of side upper rails within the respective cavity such that the connection between each of the side aerodynamic inserts and the side upper rails is not within a path of airflow over the front aerodynamic insert when in use.

14. The cargo transport of claim 13, wherein the front aerodynamic insert and each of the plurality of side aerodynamic inserts have a similar shape.

15. A cargo transport comprising:
a cargo area defined by a front wall, a plurality of side walls, and a roof;
a front upper rail disposed between the front wall and the roof and configured to couple the front wall to the roof;
a plurality of side upper rails disposed between the plurality of side walls and the roof and configured to couple the plurality of side walls to the roof; and
a front aerodynamic insert coupled to the front upper rail,
wherein the front aerodynamic insert includes a body configured to fit within a cavity of the front upper rail to couple the front aerodynamic insert to the front upper rail,
wherein the front aerodynamic insert includes an outer surface configured to direct airflow from the front wall onto the roof, the outer surface having a convex curved portion adjacent to the front wall and a concave curved portion extending from the convex curved portion.

16. The cargo transport of claim 15, wherein the outer surface of the front aerodynamic insert transitions seamlessly from the convex curved portion to the concave curved portion.

17. The cargo transport of claim 16, wherein the front aerodynamic insert is configured to be snap-fit to the front upper rail.

18. The cargo transport of claim 15, further comprising a plurality of side aerodynamic inserts coupled to the plurality of side upper rails.

19. The cargo transport of claim 18, wherein the front aerodynamic insert and the plurality of side aerodynamic inserts have a similar shape.

20. The cargo transport of claim 15, wherein the front aerodynamic insert is formed from a flexible material.
